(19) United States
(12) Patent Application Publication
(10) Pub. No.: US 2017/0009718 A1
(43) Pub. Date: Jan. 12, 2017

(54) OIL DEFLECTOR ASSEMBLY FOR FUEL INJECTOR

(71) Applicant: Caterpillar Inc., Peoria, IL (US)

(72) Inventor: Diego Caceres, Dunlap, IL (US)

(73) Assignee: Caterpillar Inc., Peoria, IL (US)

(21) Appl. No.: 15/274,015

(22) Filed: Sep. 23, 2016

(51) Int. Cl. F02M 55/00

(52) U.S. Cl. CPC F02M 55/004

(57) ABSTRACT

The oil deflector assembly for a fuel injector is disclosed. The oil deflector assembly includes a first ring disposed around a first extending portion of a case portion of the fuel injector. The oil deflector assembly further includes a second ring disposed around a second extending portion of a body portion of the fuel injector. The second ring includes a first portion engaging with a second step portion of the body portion. The first portion includes an inner surface engaging with the second extending portion of the body portion and an outer surface. A plurality of orifices extends between the inner surface and the outer surface to allow entry of fluid into the fuel injector. A second portion extends from the first portion of the second ring and is received within the first ring.

### TECHNICAL FIELD

The present disclosure relates to a fuel injector, and more particularly to an oil deflector assembly for the fuel injector of an internal combustion engine.

### BACKGROUND

Generally, a fuel injector includes a body and a case joined together to accommodate multiple moving parts, such as a plunger and valve elements, to inject fuel into a cylinder. Operation of the valve elements and the plunger is controlled, typically, by hydraulic actuators or electronic actuators. Generally, the fuel injector activated using hydraulic actuators use a fluid at high pressure for actuating the valve elements and the plunger inside the fuel injector for injecting fuel in to the cylinder at high pressure. The fluid that gets into the fuel injector has the ability to conduct debris inside the fuel injector. This may cause seizure of the fuel injector and premature failure of the moving parts of the fuel injector, thereby reduce operating performance of the internal combustion engine.

U.S. Pat. No. 5,678,767, hereinafter referred to as the '767 patent describes a fuel injector with contaminant deflector. The fuel injector with contaminant deflector includes a frusto-conical contaminant particle deflector mounted within a valve body of an automotive engine fuel injector, surrounding a fuel injector valve element. An inner clearance space between the valve element and an open end of the deflector receives fuel flow when the injector valve element is moved to allow fuel flow. Contaminant particles are caused to move along a path extending radially out of the fuel stream and into a dead zone outside the perimeter of the deflector where they tend to remain so as to avoid any effects on the performance of the fuel injector. However, the fuel injector with contaminant deflector as disclosed in the '767 patent fails to disclose filtering of fluid entering in the fuel injector.

### SUMMARY OF THE DISCLOSURE

In one aspect of the present disclosure, an oil deflector assembly for a fuel injector is provided. The fuel injector includes a case portion, and a body portion coupled to the case portion. The oil deflector assembly includes a first ring disposed around a first extending portion of the case portion. The first ring includes a first end surface adapted to engage with a first step portion of the case portion and a second end surface opposite to the first end surface. The oil deflector assembly further includes a second ring disposed around a second extending portion of the body portion. The second extending portion of the body portion is threadably received within the first extending portion of the case portion. The second ring includes a first portion adapted to engage with a second step portion of the body portion. The first portion includes an inner surface adapted to engage with the second extending portion of the body portion. The first portion further includes an outer surface distal to the inner surface. The first portion also includes a plurality of orifices extending between the inner surface and the outer surface to allow entry of fluid into the fuel injector therethrough. The second ring further includes a second portion extending from the first portion. The second portion is received within the first ring. A step portion defined by the first portion and the second portion of the second ring is adapted to engage with the second end surface of the first ring.

Other features and aspects of this disclosure will be apparent from the following description and the accompanying drawings.

### BRIEF DESCRIPTION OF THE DRAWINGS

FIG. 1 is a side view of a fuel injector having an oil deflector assembly;

FIG. 2 is an exploded view of the oil deflector assembly of FIG. 1 showing a first ring and a second ring thereof;

FIG. 3 is a side sectional view of the first ring of the oil deflector assembly of FIG. 2;

FIG. 4 is a sectional view of the second ring of the oil deflector assembly of FIG. 2; and

FIG. 5 is a schematic representation of a flow of fluid entering into the fuel injector through the oil deflector assembly.

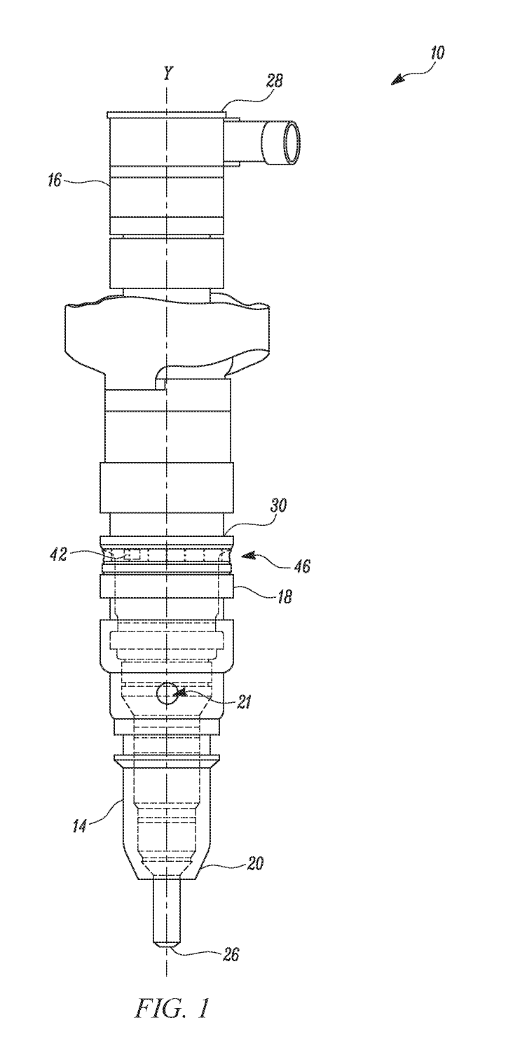

### DETAILED DESCRIPTION

Wherever possible, the same reference numbers will be used throughout the drawings to refer to the same or the like parts. Referring to FIG. 1, a side view of a fuel injector 10 is illustrated. In the illustrated embodiment, the fuel injector 10 is a hydraulically-actuated fuel injector. The fuel injector 10 injects fuel into a cylinder (not shown) of an engine (not shown) during combustion process. The fuel injector 10 is fluidly communicated with a fuel supply system (not shown) of the engine. The fuel injector 10 is also fluidly communicated with a hydraulic system (not shown) of the engine. The hydraulic system supplies pressurized fluid to the fuel injector 10 for actuating the fuel injector 10, and hence the fuel injector 10 does inject or spray the fuel to the cylinder of the engine. The fuel injector 10 is mounted on a cylinder head (not shown) of the engine. Specifically, the fuel injector 10 is positioned in a bore defined within the cylinder head of the engine.

The fuel injector 10 is received through the bore of the cylinder head. Multiple fluid passages are defined in the cylinder head around the bore. Further, the multiple fluid passages are in fluid communication with the fuel injector 10. One or more of the multiple fluid passages receive the fuel from the fuel supply system. Similarly, one or more of the multiple fluid passages receive the fluid from the hydraulic system.

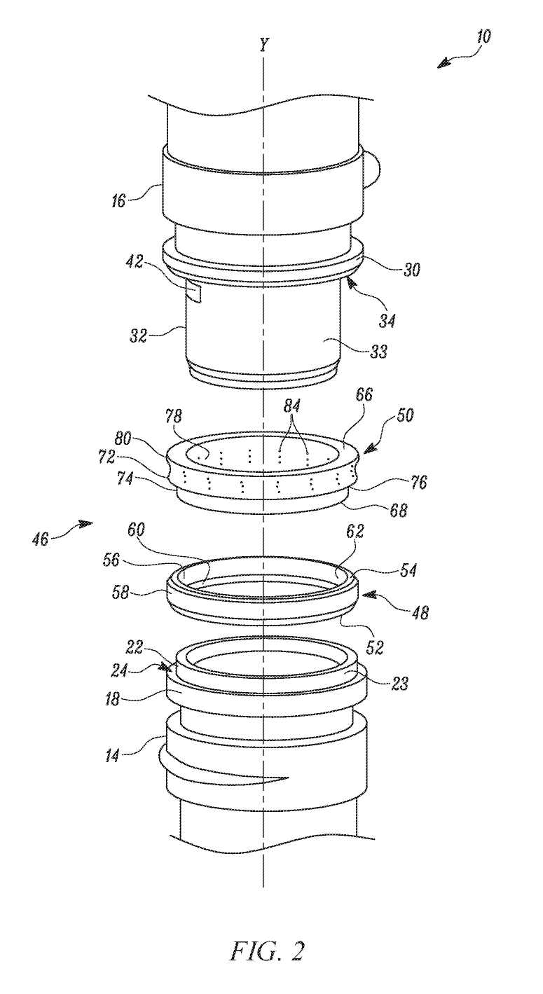

Referring to FIG. 1 and FIG. 2, the fuel injector 10 includes a case portion 14 and a body portion 16 coaxially positioned along a longitudinal axis ‘Y’ and coupled to the case portion 14. The case portion 14 is received within the bore of the cylinder head. The case portion 14 has a first end 18 coupled with the body portion 16 and a second end 20. A fuel passage having a fuel inlet 21 is formed in the case portion 14 to receive the fuel from the fuel supply system. Although not shown, the case portion 14 may receive components including, but not limited to, a plunger assembly and a needle valve assembly. The plunger assembly and the needle valve assembly are operated to spray the fuel through a nozzle outlet 26 of the fuel injector 10. The nozzle outlet 26 is received through the second end 20 of the case portion 14. The case portion 14 includes a first extending portion 22 coaxially extending from the first end 18 of the case portion 14. An outer diameter of the first extending portion 22 is less than an outer diameter of the first end 18 of the case portion 14, such that a first step portion 24 of the case portion 14 is defined between the first extending portion 22 and the first end 18 of the case portion 14.

The body portion 16 has a first end 28, and a second end 30 coupled to the first end 18 of the case portion 14. The body portion 16 includes a second extending portion 32 coaxially extending from the second end 30 of the body portion 16. An outer diameter of the second extending portion 32 is less than an outer diameter of the second end 30, such that a second step portion 34 of the body portion 16 is defined between the second extending portion 32 and the second end 30 of the body portion 16. The second extending portion 32 of the body portion 16 is threadably received within the first extending portion 22 of the case portion 14. The body portion 16 receives various components including, but not limited to, a hydraulic actuator unit (not shown). The body portion 16 includes a first fluid inlet 42 and a second fluid inlet (not shown), collectively and referred to as ‘the fluid inlets 42’ hereinafter. The fluid inlets 42 are defined in the second extending portion 32 adjacent to the second step portion 34 of the body portion 16. The hydraulic actuator unit is in fluid communication with the fluid inlets 42, such that the pressurized fluid received from the hydraulic system is communicated with the hydraulic actuator unit via the fluid inlets 42. The hydraulic actuator unit further actuates the plunger assembly to operate the needle valve assembly to selectively open the nozzle outlet 26 to inject the fuel through the nozzle outlet 26 to the cylinder of the engine. The hydraulic actuation unit also includes a fluid drain (not shown) formed in the body portion 16 adjacent to the first end 28 of the body portion 16. The fluid drain is connected to a fluid reservoir via a drain line (not shown). Upon actuating the hydraulic actuator unit, the fluid exits through the fluid drain. The fluid exits from the fluid drain flows through the drain line and collected in the fluid reservoir.

The fuel injector 10 further includes an oil deflector assembly 46 coaxially disposed along the longitudinal axis ‘Y’ between the case portion 14 and the body portion 16 of the fuel injector 10. More specifically, the oil deflector assembly 46 is removably disposed between the first step portion 24 of the case portion 14 and the second step portion 34 of the body portion 16. In an assembled condition of the case portion 14 and the body portion 16, the oil deflector assembly 46 covers the fluid inlets 42 and defines multiple flow areas around the first extending portion 22 of the case portion 14 and the second extending portion 32 of the body portion 16 for the fluid to flow through the fluid inlets 42, and then to the hydraulic actuator unit. In one example, the oil deflector assembly 46 is made of elastomeric material, such as rubber and fiber reinforced nylon, so that the oil deflector assembly 46 is capable of allowing the pressurized fluid to flow into the fuel injector 10 through the fluid inlets 42. In another example, the oil deflector assembly 46 is made of metal.

Referring to FIG. 2, the oil deflector assembly 46 includes a first ring 48 and a second ring 50 positioned above the first ring 48. As illustrated, the first ring 48 and the second ring 50 of the oil deflector assembly 46 are disposed around the first extending portion 22 of the case portion 14, and the second extending portion 32 of the body portion 16, respectively. More specifically, the first ring 48 and the second ring 50 are removably disposed around the first extending portion 22 of the case portion 14, and the second extending portion 32 of the body portion 16, respectively.

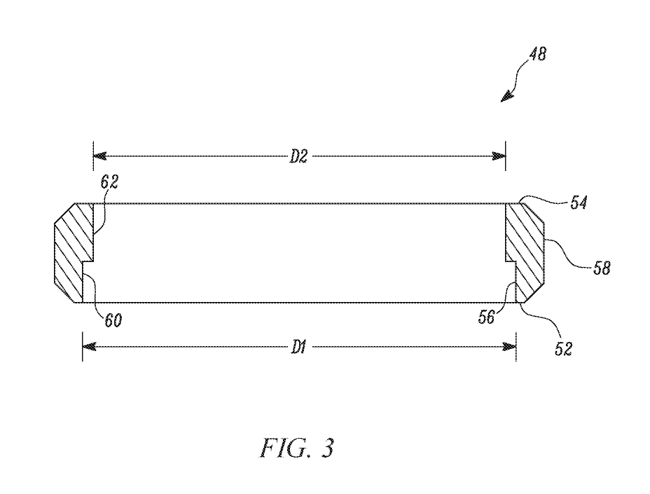

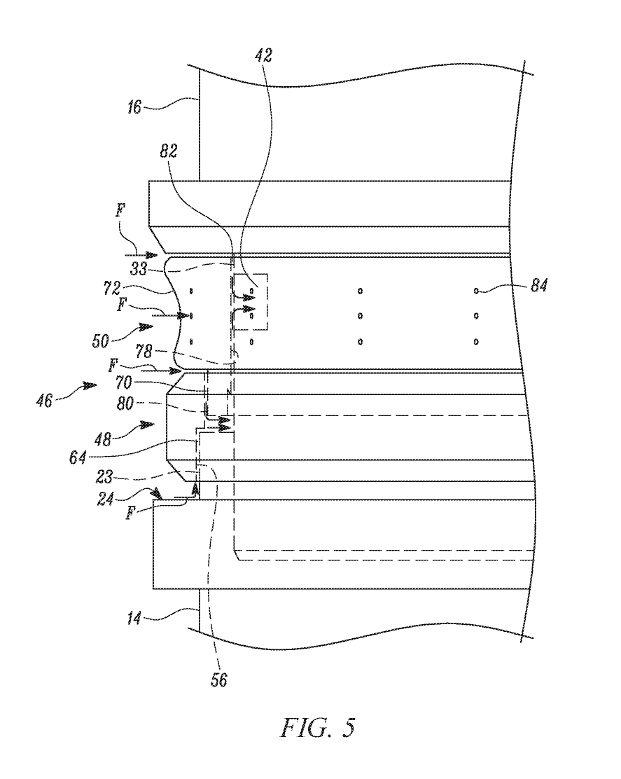

Referring to FIG. 3, the first ring 48 has a first end surface 52 and a second end surface 54 opposite to the first end surface 52. A distance between the first end surface 52 and the second end surface 54 defines a length of the first ring 48. The first end surface 52 engages with the first step portion 24 of the case portion 14. The first ring 48 includes an inner surface 56 and an outer surface 58 distal to the inner surface 56. A distance between the inner surface 56 and the outer surface 58 defines a thickness of the first ring 48. The first ring 48 has a first portion 60 and a second portion 62. The first portion 60 has an inner diameter ‘D1’ greater than an inner diameter ‘D2’ of the second portion 62. The first portion 60 of the first ring 48 is engaged with the first extending portion 22 of the case portion 14. The second portion 62 of the first ring 48 is engaged with the second ring 50. A first clearance 64 (shown in FIG. 5) is defined between an outer surface 23 of the first extending portion 22 and the inner surface 56 of the first portion 60 of the first ring 48. The first clearance 64 may range from 0.1 millimeter (mm) to 0.3 mm.

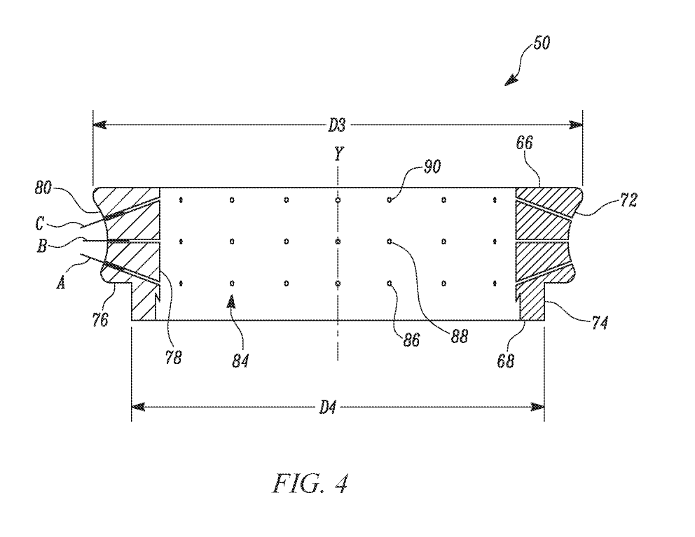

Referring to FIG. 4, the second ring 50 has a first end surface 66 and a second end surface 68 distal to the first end surface 66. A distance between the first end surface 66 and the second end surface 68 defines a length of the second ring 50. The first end surface 66 of the second ring 50 is engaged with the second step portion 34 of the body portion 16. The second ring 50 includes a first portion 72 and a second portion 74. The second portion 74 is arranged below the first portion 72 co-axial along the longitudinal axis ‘Y’ (shown in FIG. 1) of the fuel injector 10. The fluid inlets 42 are covered by the second ring 50 as shown in FIG. 5. The first portion 72 has a first outer diameter ‘D3’ and the second portion 74 has a second outer diameter ‘D4’. The first outer diameter ‘D3’ is greater than the second outer diameter ‘D4’; as such a step portion 76 is defined between the first portion 72 and the second portion 74. The step portion 76 of the second ring 50 engages with the second end surface 54 of the first ring 48.

The second ring 50 has an inner surface 78 and an outer surface 80 distal to the inner surface 78. A distance between the inner surface 78 and the outer surface 80 defines a thickness of the second ring 50. The thicknesses of the first portion 72 and the second portion 74 are different, as the first outer diameter ‘D3’ and the second outer diameter ‘D4’ of the first portion 72 and the second portion 74, respectively, are different. However, in another example, the thicknesses of the first portion 72 and the second portion 74 may be equal. The second portion 74 is adapted to engage with the second portion 62 of the first ring 48. A second clearance 70 (shown in FIG. 5) is defined between the outer surface 80 of the second portion 74 of the second ring 50 and the inner surface 56 of the second portion 62 of the first ring 48. In one example, the second clearance 70 may range from 0.1 mm to 0.3 mm. The fluid flows through the second clearance 70 and enters into the fuel injector 10 through the fluid inlets 42 formed in the body portion 16. Further, a third clearance 82 (shown in FIG. 5) is defined between an outer surface 33 of the second extending portion 32 and the inner surface 78 of the first portion 72 of the second ring 50. In one example, the third clearance 82 may range from 0.1 mm to 0.3 mm, such that the fluid flows through the third clearance 82 and enters into the fuel injector 10 through the fluid inlets 42.

The first portion 72 of the second ring 50 includes multiple orifices 84 extending between the inner surface 78 and the outer surface 80 of the second ring 50. In an example, each of the orifices 84 may have a diameter of 100 micron. Also, the orifices 84 may have different orientations for allowing entry of fluid into the fuel injector 10 therethrough. In the illustrated embodiment, the first portion 72 includes three sets of orifices, such as a first set of orifices 86, a second set of orifices 88 and a third set of orifices 90. The first set of orifices 86 is oriented along a line ‘A’, which is defined at a first acute angle with respect to the longitudinal axis ‘Y’. The second set of orifices 88 is oriented along a line ‘B’, which is perpendicular to the longitudinal axis ‘Y’. The third set of orifices 90 is oriented along a line ‘C’, which is defined at a second acute angle with respect to the longitudinal axis ‘Y’. In the illustrated example, the first acute angle and the second acute angle may be same. In another example, the first acute angle and the second acute angle may be different. In other examples, the orientation of the orifices 84 may be defined based on various factors including, but not limited to, a location of the fluid inlets 42 and a pressure of the fluid at which the fluid is supplied to the fuel injector 10 from the hydraulic system. The fluid entering the fluid inlets 42 via the oil deflector assembly 46 is filtered while entering the first clearance 64, the second clearance 70, the third clearance 82, and the orifices 84. Thus entry of any debris and foreign particles present in the fluid inside the hydraulic actuator unit is restricted.

### INDUSTRIAL APPLICABILITY

The present disclosure relates to the oil deflector assembly 46 for the fuel injector 10. The oil deflector assembly 46 includes the first ring 48 and the second ring 50. The oil deflector assembly 46 is disposed around the fluid inlets 42 defined in the body portion 16 of the fuel injector 10. The oil deflector assembly 46 seals the joint between the case portion 14 and the body portion 16 of the fuel injector 10, thereby restricts mixing of the fuel with the fluid that is used for actuating the plunger assembly. The first ring 48 and the second ring 50 of the oil deflector assembly 46 are disposed around the first extending portion 22 of the case portion 14 and the second extending portion 32 of the body portion 16, respectively. Further, the oil deflector assembly 46 defines the first clearance 64, the second clearance 70, and the third clearance 82 between each of the first extending portion 22 of the case portion 14 and the second extending portion 32 of the body portion 16 for providing increased number of flow areas for regulating flow of fluid inside the body portion 16 of the fuel injector 10. The orifices 84 provided in the first ring 48 further increases the number of flow areas for the fluid. In addition, the first clearance 64, the second clearance 70, the third clearance 82, and the orifices 84 are designed in such a way that any debris or foreign particles present in the fluid is filtered out while the fluid entering into the fuel injector 10 through the first clearance 64, the second clearance 70, the third clearance 82, and the orifices 84.

FIG. 5 illustrates a schematic representation of a flow of fluid ‘F’ through the oil deflector assembly 46. The fluid available in the fluid passages passes through the first clearance 64, the second clearance 70, the third clearance 82, and the orifices 84 and enters into the fuel injector 10 through the fluid inlets 42. The fluid entering through the first clearance 64 flows through the inner surface 56 of the first ring 48 and is directed inside the first portion 60 of the second ring 50. Similarly, the fluid entering through the third clearance 82 flows through the inner surface 78 of the first portion 72 of the second ring 50 and is directed inside the first portion 72 of the second ring 50. The fluid entering through the second clearance 70 is redirected by the first portion 72 of the second ring 50 towards the second end surface 54 of the second ring 50.

The fluid also enters through the orifices 84 and flows through the inner surface 78 of the second ring 50. The fluid entering through the first clearance 64, the second clearance 70, and the third clearance 82 of the second ring 50 flows through the inner surface 78 of the second ring 50. The second ring 50 directs the fluid entered inside the oil deflector assembly 46 towards the fluid inlets 42. Thus the fluid entering into the fuel injector 10 through the fluid inlets 42 actuates the hydraulic actuator unit of the fuel injector 10.

The fluid is filtered while flowing through the first clearance 64, the second clearance 70, the third clearance 82, and the orifices 84. In an example, the debris having large sizes present in the fluid is filtered by the first clearance 64, the second clearance 70, and the third clearance 82, as maximum width of the first clearance 64, the second clearance 70, and the third clearance 82 is below 0.2 mm. The debris having small sizes is filtered while flowing through the orifices 84 as the diameter of each of the orifices 84 is less than 100 micron. Furthermore, the orifices 84 are oriented at different angles to provide enhanced flow of fluid through the orifices 84 and effective filtering of the fluid.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An oil deflector assembly for a fuel injector, the fuel injector including a case portion and a body portion coupled to the case portion, the oil deflector assembly comprising:
a first ring disposed around a first extending portion of the case portion, the first ring including a first end surface adapted to engage with a first step portion of the case portion and a second end surface opposite to the first end surface; and
a second ring disposed around a second extending portion of the body portion, the second extending portion of the body portion being threadably received within the first extending portion of the case portion, the second ring including:
a first portion adapted to engage with a second step portion of the body portion, wherein the first portion includes:
an inner surface adapted to engage with the second extending portion of the body portion;
an outer surface distal to the inner surface; and
a plurality of orifices extending between the inner surface and the outer surface to allow entry of fluid into the fuel injector therethrough; and
a second portion extending from the first portion, and received within the first ring, wherein a step portion defined by the first portion and the second portion is adapted to engage with the second end surface of the first ring.
